(19) United States
(12) Patent Application Publication
(10) Pub. No.: US 2006/0065734 A1
(43) Pub. Date: Mar. 30, 2006

(54) Dual scanner signal acquisition

(75) Inventors: William Sackett, Rocky Point, NY (US); Anthony Biuso, South Setauket, NY (US); Ed Barkan, Miller Place, NY (US); Frederick Schuessler, Baiting Hollow, NY (US); James R. Giebel, Centerport, NY (US); Wynn Aker, Manorville, NY (US)

Correspondence Address: WATTS HOFFMANN CO., L.P.A., PO Box 99839, Cleveland, OH, 44199-0839, US

(73) Assignee: Symbol Technologies, Inc.

(21) Appl. No.: 10/955,988

(22) Filed: Sep. 30, 2004

(51) Int. Cl. G06K 7/10

(52) U.S. Cl. 235/462.25

(57) ABSTRACT

A system and method for processing scanner signals by storing both a standard digitizer signal and a more detailed digitizer signal for decoding. The decoder can then use the standard digitizer signal by default and in those cases when the bar code pattern cannot be decoded using the standard digitizer signal the decoder may access the more detailed digitizer signal.

### TECHNICAL FIELD

The invention relates generally to optical scanners, and in particular to scanners used for scanning optical codes such as bar code symbols.

### BACKGROUND

Optical codes are patterns made up of image areas having different light reflective or light emissive properties, which are typically assembled in accordance with a priori rules. The term “bar code symbol” is sometimes used to describe certain kinds of optical codes. The optical properties and patterns of optical codes are selected to distinguish them in appearance from the background environments in which they are used. Devices for identifying or extracting data from optical codes are sometimes referred to as “optical code readers” of which bar code scanners are one type. Optical code readers are used in both fixed or portable installations in many diverse environments such as in stores for check-out services, in manufacturing locations for work flow and inventory control, and in transport vehicles for tracking package handling. The optical code can be used as a rapid, generalized means of data entry, for example, by reading a target bar code from a printed listing of many bar codes. In some uses, the optical code reader is connected to a portable data processing device or a data collection and transmission device. Frequently, the optical code reader includes a handheld sensor that is manually directed at a target code.

Most scanning systems, or scanners, generate a beam of light which reflects off a bar code symbol so the scanning system can receive the reflected light. The system then transforms that reflected light into electrical signals, digitizes the signals into a digital bar pattern (DBP) signal, and decodes the DBP signal to extract the information embedded in the bar code symbol. Scanning systems of this type are described in U.S. Pat. Nos. 4,251,798; 4,360,798; 4,369,361; 4,387,297; 4,409,470; and 4,460,120, all of which have been assigned to Symbol Technologies, Inc.

In recent years, enhanced signal processing techniques have been developed for integrated scanners and decoded scan engines. The enhanced signal processing techniques convey transition strength information in addition to the basic transition timing information that is provided by traditional signal digitizers. Transition strength information can be helpful in distinguishing between noise of defects that cause relatively weak transmissions between light and dark and bar space transitions that generally produce stronger transistors. One example of an enhanced scanner signal is the multibit digitized signal that is described in U.S. Pat. No. 5,302,813 to Goren, assigned to Symbol Technologies, Inc. and incorporated herein by reference in its entirety. While these scanner signals provide more detailed information about the analog signal being received by the detector, they often require additional time and circuitry to construct and decode as compared to standard DBP signals.

### SUMMARY

Data from a scan of a bar code is converted into at least two digital representations of varying detail for decode. The at least two digital representations are stored for access by the decoder so that any of the representations can be accessed to decode the bar code in the event that one of the representations does not enable a successful decode.

In the described embodiment, a detection signal that has elements, such as peaks in amplitude, corresponding to transitions between light and dark on a surface is received. The detection signal is converted into a first bar code signal that represents the timing of the elements. The detection signal is converted into a second bar code signal that represents the timing of the elements and the strength of the elements. The first and second bar code signals are saved for decoding.

In one exemplary embodiment, tracking threshold data is calculated that is a running average of the amplitude of the detection signal. A high sensitivity digital bar pattern is generated from the detection signal using a high sensitivity threshold. The high sensitivity bar pattern is a series of pulses that change state at each peak in the detection signal that exceeds the high sensitivity threshold. The detection signal is converted to the second bar code signal by sampling the detection signal and the tracking threshold data at each state change in the high sensitivity digital bar pattern. This second bar code signal is saved for decoding by saving the high sensitivity bar pattern in a first buffer and the sampled amplitude and tracking threshold data in a second buffer. According to a feature of one embodiment, the sampled amplitude and tracking threshold data are normalized by dividing each sampled amplitude by a corresponding tracking threshold and saving the normalized amplitude in the second buffer. In this case, the detection signal is converted to the first bar code signal by constructing an output digital bar pattern comprising a series of pulses that change state at each occurrence of a normalized amplitude that exceeds one. The first bar code signal is then stored in a third buffer.

In an alternative embodiment, the second bar code signal is generated by sampling the detection signal when the high sensitivity bar pattern changes state and selecting one of a plurality of strength levels based on an amount the detection signal exceeded the high sensitivity threshold to be saved in the second buffer. This simplified timing and strength signal may be used advantageously as a single stored signal to replace more detailed signals that require more extensive hardware and decoder complexity.

The decoder may control the bandwidth within which the detection signal is amplified in response to failed attempts to decode to further extend the functional range of the scanner.

### BRIEF DESCRIPTION OF THE DRAWINGS

FIG. 1 is a functional overview of a scanner that incorporates an embodiment of the present invention;

FIG. 2 is a block diagram of signal processing components that can be used to practice an embodiment of the present invention; and

FIGS. 3A-3F are timing diagrams of signals that are present during practice of an embodiment of the present invention;

FIG. 4 is a block diagram of signal processing components that can be used to practice an alternative embodiment of the present invention;

FIGS. 5A-5F are timing diagrams of signals that are present during practice of the alternative embodiment of the present invention; and

FIG. 6 is a block diagram of a scanner system that includes decoder bandwidth control according to an embodiment of the present invention.

### DETAILED DESCRIPTION OF PREFERRED EMBODIMENTS

FIG. 1 shows a simplified embodiment of a bar code scanner 100. The bar code scanner depicted in FIG. 1 is but one example of a scanner that can be used to practice the present invention, other types of scanners may be used to practice the signal encoding technique described below. A user aims the scanner 100 at a bar code symbol 170 without physically touching it. Typically, scanner 100 operates several inches from the bar code symbol being read. The scanner 100 is shown as housed in a gun-shaped in a housing 155 having a pistol grip handle 153, however the scanner may be housed in stationary housing such as bi-optic scanners found at check out lines in grocery stores. A movable trigger 154 on handle 153 allows a user to activate a light beam 151 (or the light beam may be on continuously in the case of the bi-optic scanner) and associated detector circuitry when the user has pointed the scanner 100 at the symbol 170.

The housing 155 contains a laser light source 146, lens 157, partially-silvered mirror 147, detector 158, oscillating mirror 159, motor 160, batteries 162, CPU 140, and digitizer circuit 145. The components shown within the hashed line indicated by reference character 165 are commonly known as a “scan engine” and control the scanning functions as well as the detection and digitization of the resulting analog signal. A decoder 175 is shown removed from the scan engine but located within the housing 155. In some applications the decoder is located in a remote location such as a user terminal. The decoder 175 receives the DBP signal from the digitizer 145 on a single signal line in the described embodiment. However, any digitizer to decoder interface that utilizes a digitizer that encodes an enhanced signal onto a reduced number of signal lines to convey transition timing and strength information can be used in the practice of the present invention.

When a user activates the scanner by pulling the trigger 154, the light source 146 generates a light beam 151 along the axis of lens 157. The lens 157, which is not necessary in all embodiments, may be a single lens or a multiple lens system. After passing through the lens 157, the beam 151 passes through the partially-silvered mirror 147, and if desired, other lenses or beam shaping structures. The beam 151 then strikes oscillating mirror 159 driven by a scanning motor 160, which together direct the beam 151 in a scanning pattern.

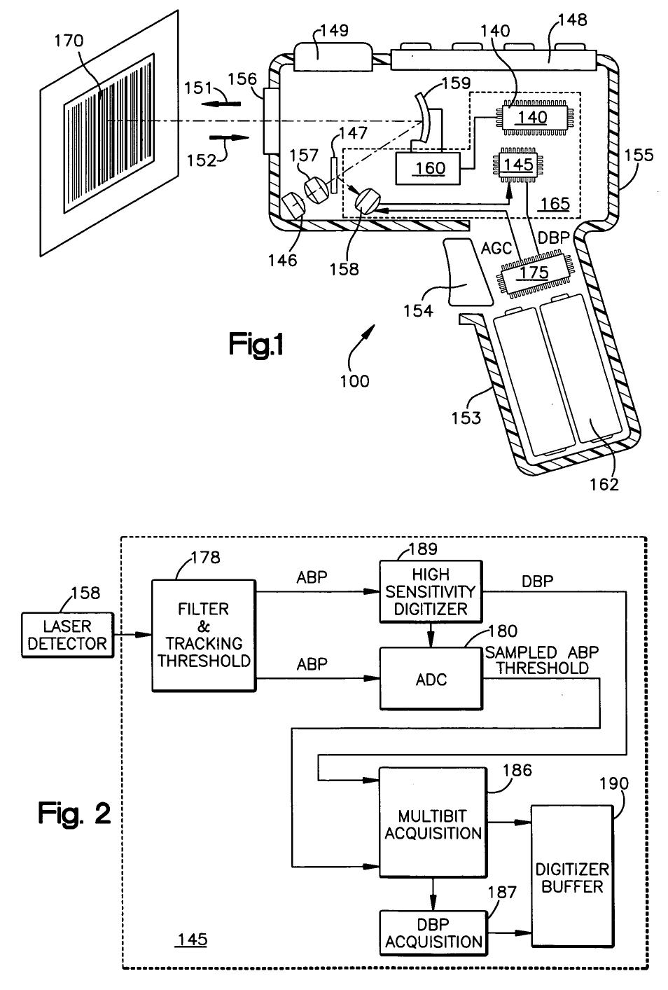

The light beam 152 is the light from the beam 151 that is reflected off the symbol 170. The beam 152 returns to the scanner 100 along a path parallel to, or at times coincident with, the beam 151. The beam 152 thus reflects off the mirror 159 and strikes the partially-silvered mirror 147. The mirror 147 reflects some of the beam 152 into a light-responsive detector 158 (also shown in FIG. 2) that converts the light beam 152 into analog electric signals. The electric signals then pass into the digitizer 145 (also shown in FIG. 2) and decoder 175 to be processed and decoded to extract the information represented by the bar code. The microprocessor 140 is used to control the operation of the motor 160 to adjust the scanning pattern and provide other control.

Overview of Standard DBP and Multibit Signals

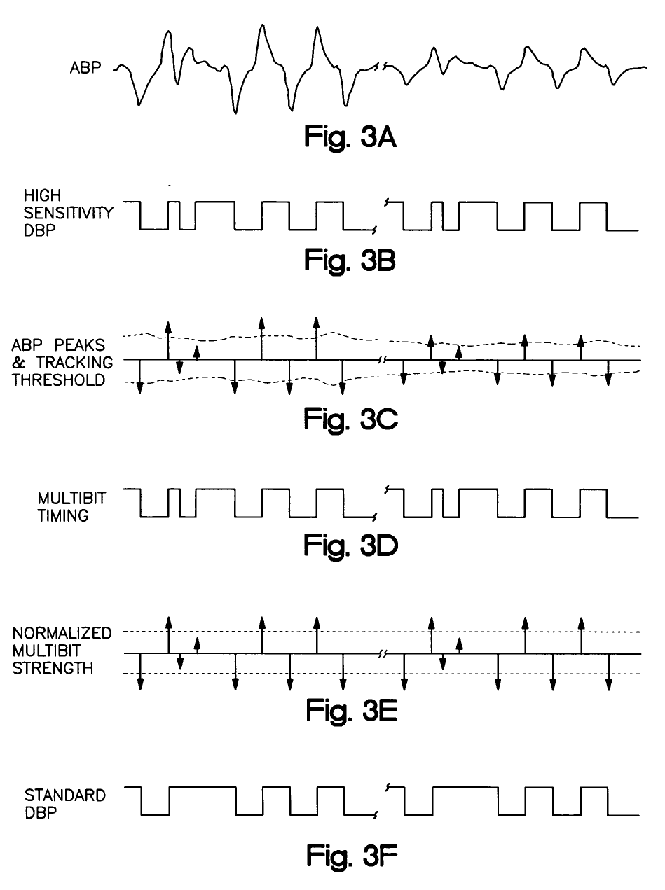

Several types of signals have been used to communicate information from the digitizer 145 in the scan engine to the decoder 175. A traditional single-DBP signal is a pulse width coded (modulated) wave representing specific transition times of the analog signal from the detector 158. These transitions are determined by taking the first derivative of the detector signal to form a signal known as the ABP (analog bar pattern). This differentiated signal will have alternating positive and negative peaks as shown in FIG. 3A. These peaks reach maximum amplitude when the laser encounters a transition between a bar and a space in the bar code. Positive and negative peaks are correlated to a space to bar transition and a bar to space transition, respectively (or vice versa depending on the particular embodiment). Small changes in the reflectivity of the bar code surface due to printing defects or dirt will also create positive and negative peaks on the first derivative signal, but will generally be smaller in amplitude than the peaks generated by real bar/space transitions.

To compensate for the presence of these noise-induced peaks in the differentiated signal, typical digitizers include circuitry that determines when a detected peak exceeds a predetermined noise threshold. Any peaks of the differentiated signal that occur which are too small to exceed this noise threshold are ignored. Any peak that occurs when the amplitude of the differentiated signal exceeds this noise threshold is registered as a real transition and the output of the digitizer, commonly called the DBP (digitized bar pattern) will change state. The DBP is typically stored as a series of pulse widths in a digitizer buffer that is accessed by the decoder to decode the signal. A beginning “polarity” (either bar or space) is also stored for each bar code and the decoder assumes that each pulse width represents an alternating polarity signal. Alternatively, the decoder may assume that the first pulse width always represents a space and in that case a first polarity element is not stored.

Another technique that is used to generate the ABP is to take the second derivative of the analog signal from the detector. In this case, whenever the ABP crosses zero a state change occurs in the DBP. For the purposes of this description, the ABP signal that is generated by taking the first derivative will be used. It will be apparent to one of skill in the art how to adapt the inventive techniques herein for practice with an ABP that represents the second derivative of the analog signal.

This standard DBP signal processing approach is relatively simple to implement, but relies heavily on the accuracy of the noise threshold. If the noise threshold is too low, the DBP will change state in response to defects or dirt on the bar code and the decoder may not be able to decode the symbol. On the other hand, if the threshold is set too high the overall working range of the scanner is reduced because as the laser spot grows large relative to the bar code elements the peaks caused by scanning across wide and narrow elements are not all of the same amplitude. The peaks caused by scanning narrow elements are lower in amplitude than peaks from wide elements. If the threshold is set too high, peaks caused by narrow elements will be missed and the symbol can fail to decode.

Various approaches have been taken to compensate for variations in bar code quality and other factors that affect what noise threshold level is appropriate in a given scan. Some digitizers, in response to a failed decode, will scan again with a different noise threshold. This approach has been successful, but often takes longer to decode because successive scans may be necessary. Another approach is for the digitizer to output strength data along with transition timing data so that the decoder can differentiate between relatively strong and weak transitions. One such digitizer is called a multibit digitizer.

A multibit enhanced scanner signal typically comprises two time-coordinated signals: timing and strength. The timing signal again indicates when (relative to a Start of Scan signal) transitions from light to dark (and vice versa) occurred. The strength signal (whether area strength or edge strength) provides additional information about the detected transitions to the decoder that can be used to determine which of the timing signal's transitions were due to print defects or noise, and which transitions truly represent the edges of the signal's bars and spaces. Essentially, the multibit digitizer enables the decoder to try multiple noise thresholds on data from a single scan rather than rescanning with a different threshold each time. For example, the decoder can try decoding using only transitions that have a strength value above a given level and if unsuccessful, attempt to decode using transitions having a strength value over some intermediate value without waiting for another scan and so on. While the multibit digitizer has enjoyed commercial success its lack of speed and the necessity for multiple parallel signal lines to convey strength information has made it less suitable for high speed or inexpensive scanners.

Dual Signal Acquisition

FIG. 2 is a block diagram of components that can be used to acquire and store both DBP and simplified multibit digitizer signals for decoding. The components operate on an analog signal from a laser detector 158 to provide both types of signals. Having both types of signals available for decoding enables the decoder to default to the standard DBP for readily decodable signals to optimize the speed of operation while being able to access multibit type data in those cases when the standard DBP is not of sufficient quality. In this manner, the scanner benefits from the fast processing time of a standard DBP signal whenever possible while being able to trade off this processing speed to access the multibit data when necessary.

A standard laser light detector 158 detects light levels reflected back from the bar code surface. The analog signal from the laser light detector is filtered and a first derivative of the analog signal (ABP) is constructed by filter and tracking threshold unit 178. In addition to the first derivative signal, a tracking threshold is calculated by taking an average of the absolute amplitude of the ABP signal. An example of a typical signal that is output by the filter and tracking threshold hardware is shown in FIG. 3A. The ABP signal is input to a high sensitivity digitizer 189 that acts as a standard DBP digitizer with a very low threshold noise level. The ABP signal and tracking threshold value are input to an analog to digital converter 180.

The output of the high sensitivity digitizer 189 in response to an input of the ABP shown in FIG. 3A is shown in FIG. 3B. The high sensitivity DBP is a pulse-width modulated signal. Each transition of the DBP signal represents an edge or transition in the bar code data. It can be seen that even the lower amplitude peaks of the ABP cause a state change in the high sensitivity digitizer output.

The output of the analog to digital converter 180 is shown in FIG. 3C. The analog to digital converter continuously samples the ABP signal and tracking threshold produced by the filter and tracking threshold unit 178. The tracking threshold is an averaging function that follows the ABP waveform and is used to detect strong edge transitions in the waveform. A multibit acquisition unit 186 chooses ABP magnitude samples and corresponding tracking threshold samples that occur at or near peaks in the ABP signal by saving those samples that occur at the same time the DBP signal changes state. The resulting ABP magnitude and threshold value samples that occur at transition times are shown in FIG. 3C. The ABP magnitude value is then treated as representing the strength of the DBP edge transition.

The high sensitivity DBP stream and the corresponding transition strength and tracking threshold values are used by the multibit acquisition unit 186 and a DBP acquisition unit 187 to produce multibit and standard DBP representations of the bar code data. The multibit and DBP acquisition units are suitably implemented, for example, in a field programmable gate array that is used to measure and save the pulse widths in the high sensitivity DBP data and the sampled ABP and tracking threshold data. The multibit acquisition unit produces the multibit timing signal as shown in FIG. 3D and normalized multibit strength signal as shown in FIG. 3E. The multibit timing signal is equivalent to the high sensitivity DBP in shown in FIG. 3B. The normalized multibit strength signal is constructed by dividing each of the ABP peak samples in the output of the analog to digital converter (shown in FIG. 3C) by the corresponding tracking threshold sample. In this way the strength value is normalized and becomes independent of the absolute signal intensity, instead depending on the relative signal strength. The strength signal becomes a series of timing impulses occurring at transition points and having a normalized magnitude relative to a threshold of 1.0, as shown in FIG. 3E. The multibit timing and normalized strength signal are stored in digitizer buffers for access by the decoder 175 in the event that a standard DBP signal is not sufficient to decode a given bar code.

The multibit representation is input to a DBP acquisition unit 187 to construct a standard DBP signal that is utilized by the decoder whenever possible. The standard DBP signal is generated by comparing the normalized multibit strength to an absolute value of 1. A strength value above 1 is considered to indicate a strong transition and is included in the standard DBP data. Any transitions with a strength below 1 are considered to be weak transitions, and are not included in the standard DBP data. The standard DBP signal is stored in buffers 190 for access by the decoder 175.

In this manner, both a multibit and standard DBP representation of ABP data is constructed and stored for access by the decoder. The decoder can default to access of the standard DBP representation for any cases in which the standard DBP representation is sufficient to successfully decode the bar code. In instances when the standard DBP representation cannot be decoded due to noise, print defects, or other conditions the decoder can access the multibit representation to attempt to decode the bar code using different noise thresholds.

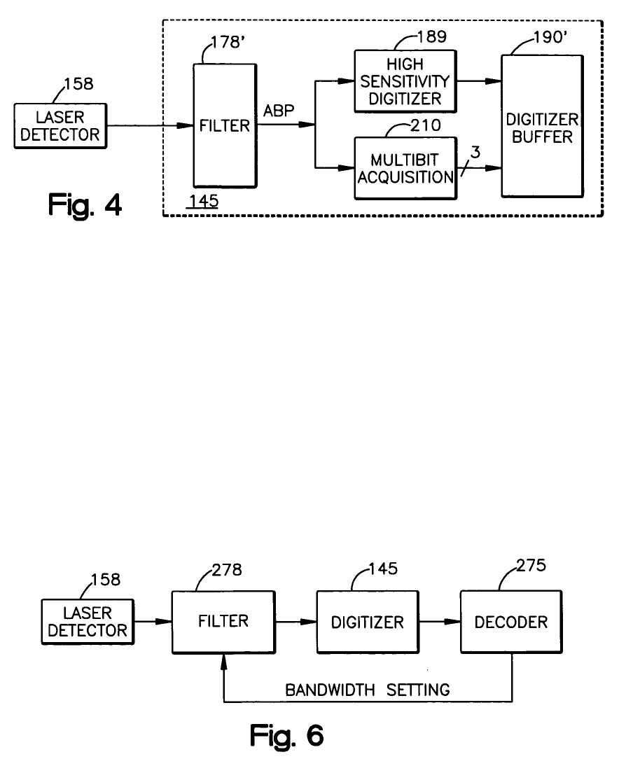

FIG. 4 is a block diagram of components that can be used to create a simplified version of a standard multibit signal. While this simplified multibit signal will be described as part of the dual signal type acquisition system that stores both DBP and multibit signals, it is contemplated that this simplified multibit signal could be implemented in place of standard multibit even in systems that do not store the standard DBP signal. The simplified multibit is cheaper to implement and less complex to decode, making it applicable in a number of inexpensive and/or high speed scanners.

As shown in FIG. 4 the laser detector 158, filter 178′, high sensitivity digitizer 189, and digitizer buffer set 190′ function similarly to that described in conjunction with FIG. 2, except that the filter 178′ does not calculate a tracking threshold. The high sensitivity digitizer timing signal is stored in the digitizer buffer set 190′ as the timing signal for the simplified multibit signal. A modified multibit acquisition comparator unit 210 provides a strength signal on three lines to be stored in the buffer set 190 as will described below.

The modified multibit acquisition unit 210 will sample the ABP signal and select samples at times corresponding to state changes in the high sensitivity digitizer DBP output. The modified multibit acquisition comparator unit 210 detects how much the selected amplitude sample exceeds the high sensitivity digitizer's threshold. The modified multibit acquisition comparator unit 210 outputs one of three levels corresponding to whether the amplitude exceeds the threshold by 25%, 50%, or 75%. This is done using voltage comparators that compare the first derivative signal to reference voltages that have been chosen to match the desired increments. For example, a reference voltage can be set 25% higher than the high sensitivity digitizer threshold. A voltage comparator that has one input connected to this reference voltage and other input connected to the sampled ABP signal will trip when the sampled amplitude of the ABP peak exceeds this reference voltage. Another voltage comparator can compare the sampled ABP signal to a reference voltage that is 50% higher than the high sensitivity threshold, and another can be connected to a reference voltage that is 75% higher than the high sensitivity threshold. It is then possible to determine how high any sampled amplitude that causes a change in the state of the output of the high sensitivity digitizer, by observing the outputs of the voltage comparators. This strength information can be then used by the decoder to decide which, if any, of the digitizer output transitions to ignore.

Since the strength determination is to be made on both positive and negative peaks of the ABP signal, a set of comparators and reference voltages can be used to measure the strength of the positive peaks and a second set used for the negative peaks. Alternatively, an inverted ABP signal is created and the voltage comparators are used to measure the strength of only one polarity of sampled amplitude values on both the inverted and uninverted signals. The second approach would allow the use of a single set of reference voltages. The outputs of these comparators can be connected by OR gates such that the output of one OR gate will go low when either the positive or negative 25% reference voltage is exceeded, the output of a second gate will go low when either the positive or negative 50% reference voltage was exceeded, etc. This can be done with comparators with open collector outputs that are wired together to perform the OR function without needing to use a separate gate component.

In a simple implementation a single integrated circuit, such as the LM339 quad voltage comparator can be used to provide total of three levels of strength data. One of the four comparators in the chip is wired to trip when a positive sampled amplitude value exceeds the digitizer threshold by 25%. Another comparator is wired to trip when a negative sampled amplitude value exceeds the digitizer threshold by 25%. Both of these comparators will be wired such that their outputs go low when the 25% reference voltage is exceeded. The outputs will then be wired together, and a pull-up resistor is connected to provide the OR function, forming a single output that will go low when either a positive or negative sampled amplitude value exceeds the 25% reference voltage. The other two comparators are wired the same way, except they will be connected to a reference voltage that is 50% higher than the digitizer threshold. Their common output goes low when a sampled amplitude value exceeds that higher reference voltage.

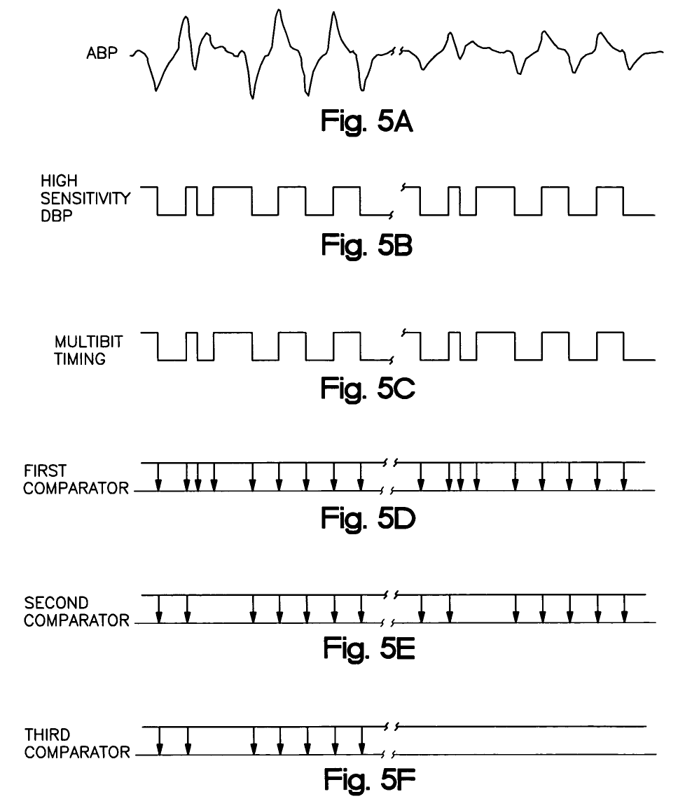

When the sampled amplitude value exceeds the threshold by more than 25%, but less than 50%, the output from the first set of comparators will be low at the moment the DBP changes state. The values of the outputs of the three comparator sets can be stored in the digitizer buffer set 190′ as shown in FIG. 4 for decoding. FIGS. 5A-5F illustrate the signals that are involved in producing the simplified multibit signal. FIGS. 5A and 5B are the ABP from the filter 178 and high sensitivity digitizer 189. The simplified multibit timing signal is shown in FIG. 5C and is the same as the digitizer output 5B. The output of the three comparator pairs, the 25% threshold “first” comparator, the 50% threshold “second” comparator, and the 75% “third” comparator are shown in FIGS. 5D, 5E, and 5F, respectively. It can be observed that the first comparator goes low at most peaks in the ABP signal, including the smallest amplitude peaks, because they all exceed 25% of the threshold. The second comparator goes low at those peaks that exceed 50%, so that several lower peaks in the ABP of FIG. 5A are not present in 5E. Likewise the third comparator goes low at those sampled amplitudes that exceed 75%, so that none of the lower amplitude peaks in the second half of the ABP signal trigger the third comparator as shown in FIG. 5F.

The comparator outputs can be sent to the digitizer buffers 190 as shown in FIG. 4 as the only representation of the ABP for decoding or in conjunction with a standard DBP signal as shown in FIG. 2. Alternatively, the values of the comparator outputs can be sent to a set of latches that temporarily store the comparator outputs for decoding and are reset every time a new sampled ABP value is received. The decoder 175 can reset the latches after reading them or alternatively, the latches can be reset without intervention of the decoder using hardware circuitry. For example, one set of latches can be used to store strength data for positive sampled amplitudes, and another set of latches can store strength data for negative sampled amplitude values. New strength data is stored in the positive sampled amplitude latch each time the digitizer trips on a positive amplitude, and the new data is stored in the negative sampled amplitude latch each time the digitizer trips on a negative amplitude. Both sets of latches will retain the data until another positive sampled amplitude or negative sampled amplitude is encountered. In this way valid data is available for decoding in each latch for the time it takes the laser spot to traverse two elements of the bar code.

FIG. 6 shows a filter 278 and decoder 275 configuration that enhances scanner performance by allowing the decoder to change a bandwidth setting on the filter/amplifier before the first derivative signal is applied to the strength measuring comparators or the digitizer. Changing bandwidth is useful because it is often necessary to make a compromise when choosing the amplifier bandwidth in a scanner. It is desirable to make the bandwidth high enough to assure maximum peak amplitude of all real edges because this makes the data more readily decodable at the extreme ends of the working range where the laser spot is getting large with respect to the bar code elements and the signal frequency is also getting higher. The edge locations will also be more accurate if the bandwidth is higher. On the other hand, if the bandwidth is too high, the signal may become noisy when reading bar code symbols that are positioned far from the scanner. For example, a low bandwidth is better for reading low density symbols that are located far from the scanner, and a higher bandwidth may be better for reading high density symbols at the end of the working range, which will be closer to the scanner than the end of the working range for low density symbols, so noise is not a problem. If the decoder can change the amplified bandwidth, the bandwidth can be optimized for each situation. For example, the decoder can change the bandwidth following a failed multibit decode to get a set of three new strength signals to attempt to decode.

The filter 278 includes circuitry that allows the decoder 275 to have control of the amplifier bandwidth. An analog switch can be used to switch additional capacitors in parallel with the capacitors that are normally in the feedback loop of the amplifiers. When the analog switch is open, the amplifier will operate with a single feedback capacitor, and its bandwidth will be relatively high. If the switch is turned on, a second capacitor will be connected in parallel with the first capacitor, reducing the bandwidth. A second switch and capacitor can be used to add a third capacitor, further reducing the bandwidth. Two analog switches and two additional capacitors can provide a total of four different bandwidths. The highest will be with both analog switches open, so the only capacitor determining bandwidth is one that is permanently connected into the circuit. A second lower bandwidth is obtained by switching a second capacitor in parallel with the first. A third is obtained by switching off the second capacitor, but switching on a third larger one, and a fourth lowest bandwidth occurs when both switches are turned on, connecting all three capacitors in parallel.

Analog switches can be used to switch capacitors on more than one amplifier stage, or to switch capacitors on a multi-pole filter in the analog chain, if one is used. In many cases FET transistors can be substituted for analog switches, or bipolar transistors can be used to connect one of a capacitor to ground, when the transistor is turned on, but which lets one end of a capacitor float when the transistor is turned off.

It can be seen from the foregoing description, that creating and storing both a standard DBP signal and a set of multibit signals allows a decoder to selectively access the multibit signals when the standard DBP signal is not decodable. Although the invention has been described with a certain degree of particularity, it should be understood that various changes can be made by those skilled in the art without departing from the spirit or scope of the invention as hereinafter claimed.

We claim:

1. An apparatus that acts on a bar code comprising:
a light detector that detects light reflected back from a surface on which a bar code may be present and provides a detection signal having peaks corresponding to the timing and strength of changes in the amount of the reflected light;
a detection signal translator that translates the detection signal and outputs a first bar code signal that represents the timing of the detection signal peaks and a second bar code signal that represents the timing of detection signal peaks, wherein the second bar code signal includes additional information about the detection signal peaks as compared to the first bar code signal; and
a plurality of buffers for storing each of the first and second digitizer signals.

2. The apparatus of claim 1 wherein the first bar code signal represents the timing of those detection signal peaks that exceed a first predetermined threshold and the second bar code signal represents the timing and amplitude of detection signal peaks.

3. The apparatus of claim 1 comprising a decoder that accesses the buffers and interprets the first bar code signal in an attempt to decode the bar code and wherein if the attempt to decode the bar code fails the decoder accesses the buffers and interprets the second bar code signal.

4. The apparatus of claim 2 comprising a detection signal tracker that calculates a detection signal tracking threshold that is an average of the absolute amplitude of the detection signal that has occurred in the bar code being acted upon and wherein the tracking threshold is input to the translator with the detection signal.

5. The apparatus of claim 4 wherein the translator comprises a sampler that samples the detection signal and tracking threshold to produce a sampler signal having elements comprising a detection signal amplitude and tracking threshold data pair.

6. The apparatus of claim 5 wherein the translator comprises a high sensitivity digitizer that produces a digitizer signal representative of the detection signal that comprises a series of pulses that change state at each peak in the detection signal having a magnitude that exceeds a high sensitivity threshold.

7. The apparatus of claim 6 wherein the translator comprises a second bar code signal generating unit that receives the digitizer signal and sampler signal and selects elements in the sampler signal that correspond in time to transitions in state of the pulses in the digitizer signal.

8. The apparatus of claim 7 wherein the second bar code signal generating unit normalizes the sampler signal by dividing the detection signal amplitude by the tracking threshold for each selected element and to form a normalized amplitude.

9. The apparatus of claim 8 wherein the second bar code signal generating unit produces the second bar code signal by transmitting the digitizer signal to a first buffer and the normalized amplitude values to a second buffer.

10. The apparatus of claim 9 comprising a first bar code signal generating unit that produces the first bar code signal by transmitting a series of pulses that changes state each time the normalized amplitude value exceeds one to a third buffer.

11. A method that processes a scanner signal comprising:
receiving a detection signal that has elements corresponding to transitions between light and dark on a surface;
converting the detection signal into a first bar code signal that represents the timing of the elements;
storing the first bar code signal for decoding;
converting the detection signal into a second bar code signal that represents the timing of the elements and the strength of the elements; and
storing the second bar code signal for decoding.

12. The method of claim 11 wherein the detection signal elements are peaks in the detection signal that occur when a transition between light and dark is scanned and wherein the peaks have an amplitude corresponding to a strength of the transition.

13. The method of claim 11 comprising decoding the first bar code signal to determine a bar code pattern and if the bar code pattern cannot be determined, decoding the second bar code signal.

14. The method of claim 12 comprising calculating tracking threshold data that is a running average of the absolute amplitude of the scanner signal.

15. The method of claim 14 comprising constructing a high sensitivity digital bar pattern from the detection signal comprising a series of pulses that change state at each peak in the detection signal that exceeds a high sensitivity threshold.

16. The method of claim 15 wherein the detection signal is converted to the second bar code signal by sampling the detection signal and the tracking threshold data at times corresponding to each state change in the high sensitivity digital bar pattern and wherein the second bar code signal is saved for decoding by saving the high sensitivity bar pattern in a first buffer and the sampled amplitude and tracking threshold data in a second buffer.

17. The method of claim 16 comprising normalizing the sampled amplitude and tracking threshold data by dividing each sampled amplitude by a corresponding tracking threshold and saving the normalized amplitudes in the second buffer.

18. The method of claim 17 wherein the detection signal is converted to the first bar code signal by constructing an output digital bar pattern comprising a series of pulses that change state at times corresponding to the occurrence of a normalized amplitude that exceeds one.

19. An apparatus that acts on a bar code comprising:
a light detector that detects light reflected back from a surface on which a bar code may be present and provides a detection signal having peaks corresponding to the timing and strength of changes in the amount of the reflected light;
a detection signal tracker that calculates a detection signal tracking threshold that is an average of the absolute amplitude of the detection signal;
a detection signal translator that translates the detection signal based on the tracking threshold to output first and second bar code signals for decoding comprising:
a sampler that samples the detection signal and tracking threshold to produce a sampler signal having elements comprising a detection signal amplitude and tracking threshold data pair;
a high sensitivity digitizer that produces a digitizer signal representative of the detection signal that comprises a series of pulses that change state at each peak in the detection signal having a magnitude that exceeds a high sensitivity threshold;
a first bar code signal generating unit that receives the digitizer signal and sampler signal and selects elements in the sampler signal that correspond in time to transitions in state of the pulses in the digitizer signal;
second bar code signal generating unit that produces the second bar code signal by transmitting a series of pulses that changes state each time the selected elements of the sampler signal have an amplitude that exceeds a predetermined threshold; and
a plurality of buffers for storing each of the first and second digitizer signals.

20. The apparatus of claim 19 comprising a decoder that accesses the buffers and interprets the second bar code signal in an attempt to decode the bar code and wherein if the attempt to decode the bar code fails the decoder accesses the buffers and interprets the first bar code signal in an attempt to decode the bar code.

21. The apparatus of claim 20 wherein the first bar code signal generating unit normalizes the sampler signal by dividing the detection signal amplitude by the tracking threshold for each selected element and saving the resulting normalized amplitude.

22. The apparatus of claim 21 wherein the first bar code signal generating unit produces the first bar code signal by transmitting the digitizer signal to a first buffer and the normalized amplitude values to a second buffer and wherein the pulses in the second bar code signal change state each time the normalized amplitude exceeds one.

23. A method that processes a scanner signal comprising:
receiving a detection signal that has elements corresponding to transitions between light and dark on a surface, wherein the detection signal elements are peaks in the detection signal that occur when a transition between light and dark is scanned and wherein the peaks have an amplitude corresponding to a strength of the transition;
calculating a tracking threshold data that is a running average of the absolute amplitude of the scanner signal;
constructing a high sensitivity digital bar pattern from the detection signal comprising a series of pulses that change state at each peak in the detection signal that exceeds a high sensitivity threshold;
converting the detection signal into a first bar code signal by sampling the detection signal and the tracking threshold data at each state change in the high sensitivity digital bar pattern, normalizing the sampled amplitude and tracking threshold data by dividing each sampled amplitude by a corresponding tracking threshold;
saving the high sensitivity bar pattern in a first buffer and saving the normalized amplitude in a second buffer;
converting the detection signal to a second bar code signal by constructing an output digital bar pattern comprising a series of pulses that change at times corresponding to an occurrence of a normalized amplitude that exceeds one; and
saving the second bar code signal in a third buffer.

24. The method of claim 23 comprising decoding the second bar code signal to determine a bar code pattern and if the bar code pattern cannot be determined, decoding the first bar code signal.

25. The apparatus of claim 2 wherein the translator comprises samples the detection signal to produce a sampler signal having elements comprising a detection signal amplitude.

26. The apparatus of claim 25 wherein the translator comprises a strength comparator unit that compares the detection signal amplitude element from the sampler signal with a plurality of threshold levels and outputs a signal that indicates which of the thresholds are exceeded by the detection signal amplitude.

27. The apparatus of claim 3 wherein the decoder comprises a bandwidth control unit that adjusts a bandwidth at which the detection signal is generated on a subsequent scan.

28. The apparatus of claim 27 wherein the decoder adjusts the bandwidth in response to a failed attempt at decoding.

29. The method of claim 12 comprising constructing a high sensitivity digital bar pattern from the detection signal comprising a series of pulses that change state at each peak in the detection signal that exceeds a high sensitivity threshold.

30. The method of claim 29 wherein the detection signal is converted to the second bar code signal by sampling the detection signal at times correspond to each state change in the high sensitivity digital bar pattern and determining which of a plurality of threshold levels the sampled detection signal exceeds and wherein the second bar code signal is saved for decoding by saving the high sensitivity bar pattern in a first buffer and saving a signal indicative of which of the thresholds is exceeded in a second buffer.

31. The method of claim 13 wherein if the bar code pattern cannot be decoded using the second bar signal, the decoder adjusts a bandwidth at which the detection signal is received for a subsequent scan.
